(19) United States
(12) Patent Application Publication
(10) Pub. No.: US 2016/0161051 A1
(43) Pub. Date: Jun. 9, 2016

(54) SYSTEM WITH EXTENDABLE RETRACTABLE TELESCOPIC ELEMENTS DEPENDING ON A LIFTING MECHANISM, LOCKABLE AND UNLOCKABLE MECHANICALLY AND AUTOMATICALLY

(71) Applicant: Roberto SALIN, Bolzano (IT)

(72) Inventor: Roberto SALIN, Bolzano (IT)

(21) Appl. No.: 14/951,895

(22) Filed: Nov. 25, 2015

(30) Foreign Application Priority Data
Dec. 5, 2014 (IT) BZ2014A052

(51) Int. Cl. F16M 11/26; F16M 11/28

(52) U.S. Cl. CPC F16M 11/26; F16M 11/28

(57) ABSTRACT

A system is described for lifting tables, chairs, bed bases, children's high chairs or other items to be lifted; which is lockable and unlockable automatically through at least one universal telescopic snap movement or in a known way comprising at least one pantograph—a vertically moveable load-bearing structure arranged between a base and the bottom of a piece of furniture or element to be lifted and a stopping device intended to keep the pantograph in a desired height position.

According to the invention the load-bearing structure is formed by at least one pantograph having a plurality of parallelograms articulated to one another whose lower vertex is articulated to the base and upper vertex is articulated to the bottom of the furniture or object to be lifted and the stopping device is an integral part of telescopic snap movement.

The present invention relates to a lifting mechanism comprising pantograph elements 6 and a lockable and unlockable universal telescopic snap movement according to the classifying part of claim 1.

### BACKGROUND OF THE INVENTION

A lifting system is described which, as well as being manual, for heavy loads requires a lifting mechanism of the type described in the Italian patent application of the same Applicant, BZ 2013 A 000 01 7 dated 18 Mar. 2013, or other known means, As is well known, for lifting heavy loads in the building sector, the mechanical sector and in the most varied sectors, there are cranes and hoists that can lift platforms, etc. bringing them to a desired height. The advantage of this system consists of a minimum height off the ground when it is at rest (in fact in some cases it may be hidden/built into the floor) and a width and length that vary according to the height to be reached. This system, which on one hand is simple and cheap, can be used for lifting tables, chairs, bed bases, beds, kitchens and the related tops, etc. and especially for children's high chairs.

In this case, in the absence of dependent lifting, if the weight to be lifted to bring it to the desired height is not excessive, if can be performed manually.

### BRIEF SUMMARY OF THE INVENTION

The object of the present invention consists of proposing a lifting system able to lift objects to different heights, i.e. to determined positions, above a resting level.

This object is obtained by a lifting system comprising pantograph elements having the characteristics of claim 1.

### BRIEF DESCRIPTION OF THE SEVERAL VIEWS OF THE DRAWING(S)

Further characteristics and details are shown in the claims and the following exemplary and non-limiting description with reference to the attached drawing in which:

FIG. 1 shows a schematic vertical section of 3 lifting mechanism in a raised position,

FIG. 2 shows a schematic vertical section of the lifting mechanism in its raised position, rotated through 90 degrees with respect to FIG. 1,

FIG. 3 shows a schematic vertical section of the lifting mechanism of FIG. 1, in a retracted position,

FIG. 4 shows a perspective view of a lifting mechanism and a variant, and

FIG. 5 shows a lateral view of the mechanism of FIG. 4.

### DETAILED DESCRIPTION OF THE INVENTION

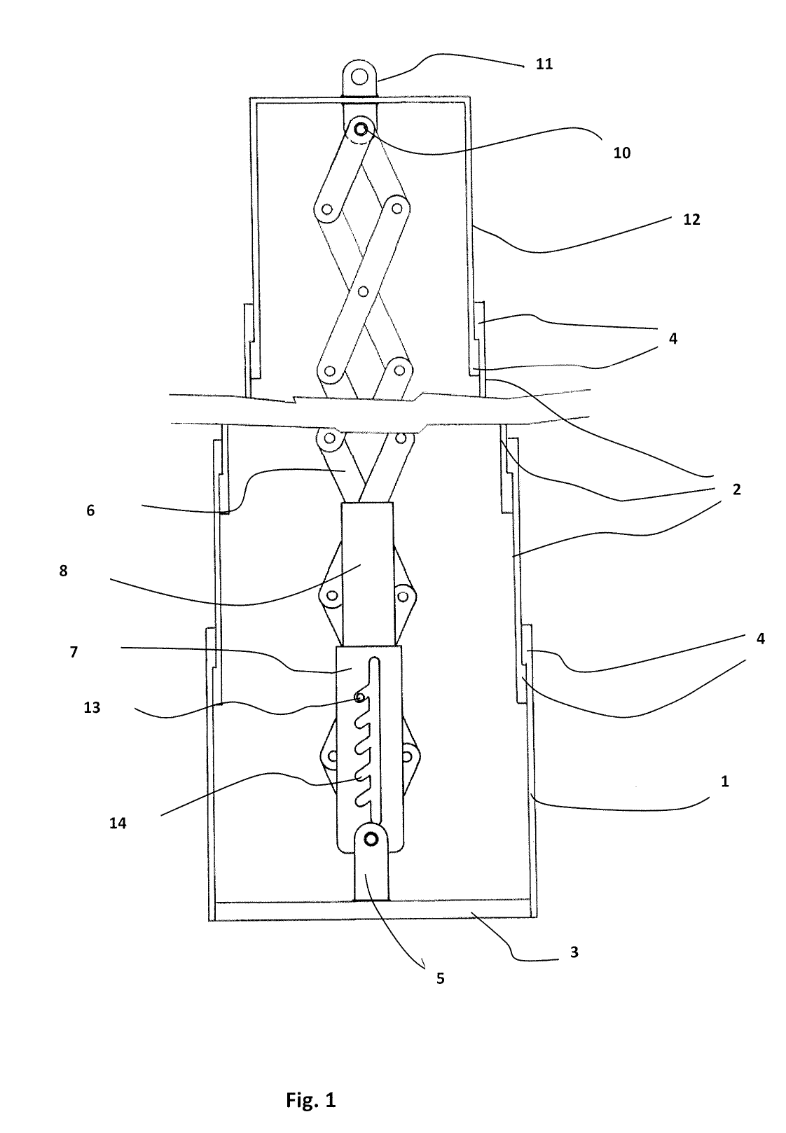

FIG. 1 represents a fixed telescopic element-foot 1 which could be other shapes not represented here.

2 indicates the extendable and retractable telescopic elements, 3 the base, 4 the end stop, 5 a lower support of an articulated parallelogram 6 and of the automatically lockable and unlockable universal telescopic snap movement 7.

8 indicates an engagement rod connected to a second articulation pin of the articulated parallelogram 6, and at the lower end the lockable and unlockable universal telescopic snap movement 7.

10 indicates the articulation of the last articulated parallelogram element, reference number 11 indicates the connection for lifting which can also be replaced if direct connection is required at the articulation 10 by the last element of the articulated parallelogram.

12 represents the cap-roof, 13 a pin or ratchet for locking the universal telescopic snap movement 7 and its housing 14.

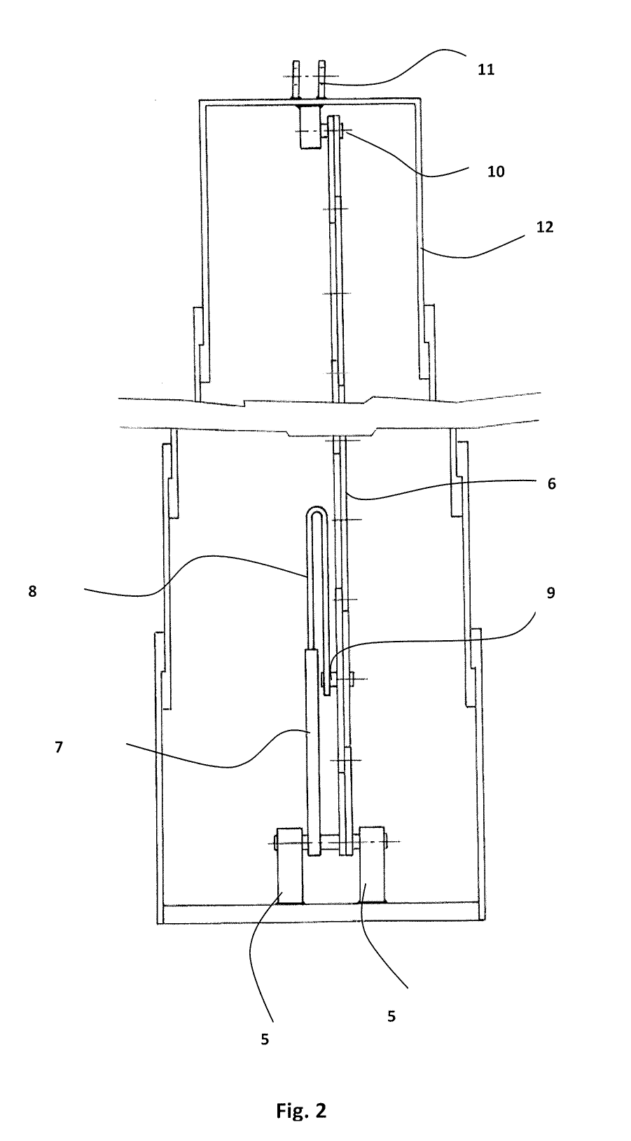

FIG. 2 represents the lower support 5 of the lockable and unlockable universal telescopic snap movement 7 with the engagement rod 8 to the articulated parallelogram 6 on the articulation pin 9 the cap-roof 12, 10 shows the articulation of the last articulated parallelogram element 6.

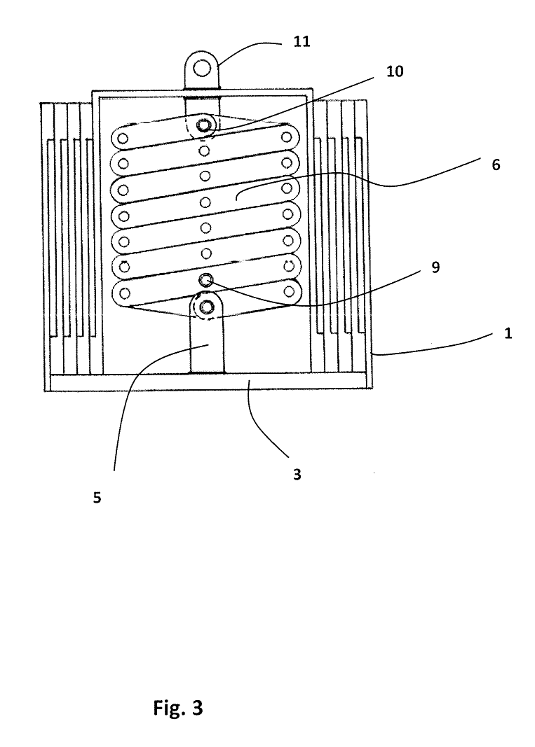

FIG. 3 represents the fixed telescopic element-foot 1 which can be any shape, while 3 indicates the base, 5 the lower support to the articulated parallelogram 6.

6 indicates the articulated parallelogram, 9 the second articulation pin of the parallelogram, 10 the articulation of the last element of the articulated parallelogram and 11 the connection for lifting.

By lifting the cap-roof 12 (or even through the articulation 10 of the articulated parallelogram) with at least one lifting connection 11 the same articulation 10 being engaged in the last element of the articulated parallelogram 6, all or part of the articulated parallelogram 6 is raised or lowered which, being engaged with the articulation pin 9 to the engagement rod 8 connected to the lockable and unlockable universal telescopic snap movement 7, is extended and retracted performing first the end stop extending itself to the full height of the universal telescopic movement itself, or in some cases shifting first from motion to idle, at the desired height becoming locked through the locking pin 13 into a housing 14.

For proper operation at least one articulated parallelogram is required and at least one lockable and unlockable telescopic snap movement 7. The housings of the telescopic movement 14 that house the locking pin 13 may be more spaced out from the subsequent or previous ones so as to allow the unlocking and lowering of the telescopic elements 2 and the articulated parallelogram/pantograph 8 without having to raise the actual articulated parallelogram 6 until its end so as to allow the locking of the pin 13 to return to the initial lowered rest position.

The articulation 10 to the last articulated parallelogram element can be engaged directly with the element to be raised and can also be articulated in a slide not depicted here.

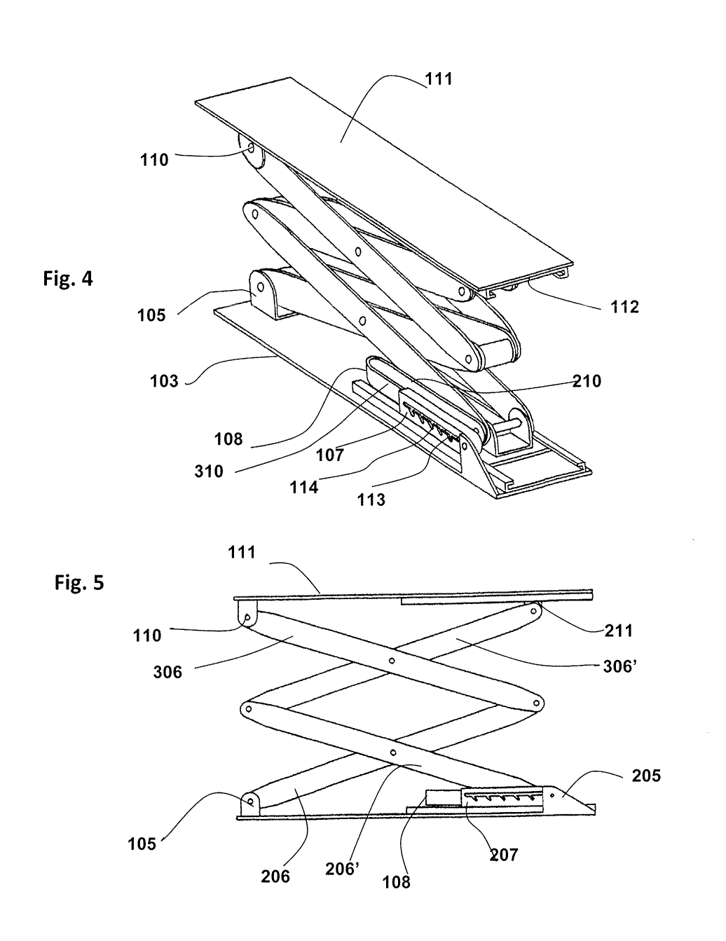

FIGS. 4 and 5 show a variation of the lifting mechanism wherein a fixed support 105 and a support 205 are fixed to a base 103 at a distance. The free end of an extension 206 of a parallelogram 108 being part of a plurality of parallelograms of a pantograph is fixed to the support 105. The free end of the other extension 206′ is actually articulated to the ends of a jaw 210 of a folded clamp 108 whose other end of the second jaw 310 carries a ratchet 113 which is engaged in a longitudinal guide 107 having snap teeth 114 wherein the ratchet 113 is able to be locked and unlocked in a pawl like way. The longitudinal guide 107 is articulated at its free end to the support 105. To allow the scissor-like movement of the pantograph, one of the extensions 306 of the upper parallelogram 106, has an articulation 110 integral to a support 111 of an object to be lifted, while its other extension 306′ has a free end articulated to a slider 211 slidable in a guide 112 integral to the support 111.

### KEY

1. fixed telescopic element-foot of any shape
2. extendable-retractable telescopic elements
3. base
4. end stop
5. lower support of the articulated parallelogram and the lockable and unlockable universal telescopic snap movement
6. articulated parallelogram/pantograph
7. lockable and unlockable universal telescopic snap movement
8. engagement rod
9. second parallelogram articulation pin
10. articulation to the last articulated parallelogram element
11. connection for lifting
12. cap-roof
13. locking pin
14. lockable and unlockable universal telescopic snap movement housing
103. base
105. fixed support
107. guide
108. clamp
110. articulation
111. rest
112. guide
113. ratchet
114. snap teeth
205. support
206. extension
206′ .extension
210. first jaw
211. slider
306. extension
306′ .extension
310. second jaw

1. A system for lifting tables, chairs, bed bases, children's high chairs or other items to be lifted, which is lockable and unlockable automatically through at least one universal telescopic snap movement or in a known way comprising at least one pantograph of a vertically moveable load-bearing structure arranged between a base and the bottom of a piece of furniture or element to be lifted and a stopping device intended to keep the pantograph in a desired height position, the load-bearing structure is formed by at least one pantograph having a plurality of parallelograms articulated to one another whose lower vertex or lower extensions of the pantograph is/are articulated to the base and upper vertex or upper extensions is/are articulated to the bottom of the furniture or object to be lifted and the stopping device is an integral, part of the lockable and unlockable universal telescopic snap movement connected to one of the ends of a rod carrying at its other end a ratchet engaged in a rectilinear groove of a plate (lockable and unlockable universal telescopic snap movement) articulated at its lower end to the base, the groove being alongside a plurality of pawl teeth arranged inclined so as to house the ratchet locking the pantograph at the desired height; to return to rest position i.e. with the pantograph closed rising until the ratchet finishes its stroke so that it can descend to the required level at a different height or can descend to rest position.

2. The mechanism according to claim 1, wherein one of the rod is folded by 180 degrees

3. The mechanism according to claim 1, wherein the hinge of the engagement rod is the second articulation of the pantograph starting from the base.

4. The mechanism according to claim 1, wherein the load-bearing structure is surrounded by telescopic elements slidable in one another of which the bottom one is integral with the base and the top one with the bottom of the furniture or the object, the first telescopic element has an inner shoulder adapted to strike against a lower outer shoulder of a subsequent telescopic element having an upper inner shoulder adapted to strike against an outer shoulder of a further telescopic element and so on for the other telescopic elements of the plurality until the last upper telescopic element striking against the upper inner shoulder of the respective lower telescopic element.

5. The mechanism according to claim 1, wherein a fixed support and a support, are fixed to a base an extension of a parallelogram being part of a plurality of parallelograms of a pantograph is articulated to the support the free end of the other extension actually being articulated to the end of a jaw of a clamp folded by 180° whose other end of the second jaw carries a ratchet which is engaged in a longitudinal guide having snap teeth in which the ratchet can be looked and unlocked in a pawl like way, the longitudinal guide is articulated at its free end to the support.

6. The mechanism according to claim 1, wherein to allow the scissor-like movement of the pantograph, one of the extensions of the upper parallelogram, has an articulation integral to a support of an object to be lifted, while its other extension has a free end articulated to a slider slidable in a guide integral to the support.
